(19) United States
(12) Patent Application Publication
(10) Pub. No.: US 2015/0139211 A1
(43) Pub. Date: May 21, 2015

(54) Method, Apparatus, and System for Detecting Rogue Wireless Access Point

(71) Applicant: Huawei Technologies Co., Ltd., Shenzhen (CN)

(72) Inventor: Ping Ji, Nanjing (CN)

(21) Appl. No.: 14/509,196

(22) Filed: Oct. 8, 2014

Related U.S. Application Data
(63) Continuation of application No. PCT/CN2014/074976, filed on Apr. 9, 2014.

(30) Foreign Application Priority Data
Nov. 19, 2013 (CN) 201310581758.4

(51) Int. Cl. H04W 48/16; H04W 12/06; H04L 29/06

(52) U.S. Cl. CPC H04W 48/16; H04L 63/0876; H04W 12/06
USPC 370/338

(57) ABSTRACT

Disclosed are a method, an apparatus, and a system for detecting a rogue wireless access point (AP) as relates to the field of communications network technologies, which is used to solve a problem of information leakage to a certain degree. An authentication client obtains a basic service set identifier (BSSID) of a radio signal to be connected and checks the BSSID of the radio signal to be connected against a valid BSSID list; the authentication client determines that an AP corresponding to the BSSID of the radio signal to be connected is a rogue AP when the BSSID of the radio signal to be connected does not exist in the valid BSSID list; and generates a prompt message. The solutions provided in the embodiments of the present invention are applicable to detecting whether an AP is a rogue wireless AP.

### CROSS-REFERENCE TO RELATED APPLICATIONS

This application is a continuation of International Application No. PCT/CN2014/074976, filed on Apr. 9, 2014, which claims priority to Chinese Patent Application No. 201310581758.4, filed on Nov. 19, 2013, both of which are hereby incorporated by reference in their entireties.

### TECHNICAL FIELD

The present invention relates to the field of information processing technologies, and in particular, to a method, an apparatus, and a system for detecting a rogue wireless access point.

### BACKGROUND

With the continuous development of network technologies, to extend a communication transmission range of data rather than limit it to wired transmission, a wireless access point (AP) is used to cover a wireless area, so that network transmission can be performed by means of a connection to a corresponding AP in the wireless area. However, a network security problem occurs concurrently. The problem is as follows: A rogue AP appears in the wireless coverage area and fakes a service set identifier (SSID) of an AP corresponding to the wireless coverage area, so that a user may access the rogue AP, thereby causing a phenomenon of information leakage.

For the phenomenon that an AP is faked to obtain confidential information, in the prior art, a specific AP generally performs interlaced scanning on all APs on a wireless network, or a specific AP is deployed independently to perform whole-process monitoring on all APs on a wireless network, so as to find a rogue AP by scanning. The specific AP obtains a radio packet frame of a radio air interface, and then determines whether an AP corresponding to the obtained radio packet frame is within a control scope. When an AP corresponding to a certain radio packet frame is not within the control scope, it is determined, using an identification rule or in a manual manner, that the AP not within the control scope is a malicious rogue AP. After determining the malicious rogue AP, the specific AP sends a deauth frame or a disassoc frame to the malicious rogue AP through a broadcast channel, to force a user connecting to the malicious rogue AP to go offline, so as to achieve a purpose of avoiding information leakage.

In the prior art, after a malicious rogue AP is determined, the following method is adopted. A specific AP sends, through a broadcast channel, a deauth frame or a disassoc frame to a user connecting to the malicious rogue AP to force the user connecting to the malicious rogue AP to go offline. However, after being forced to go offline, the user performs reconnection automatically. Therefore, the specific AP needs to send a deauth frame or a disassoc frame on a timed and persistent basis to force the user connecting to the AP to go offline. Therefore, leakage of information still occurs during a subsequent connection of the user to the malicious rogue AP.

### SUMMARY

Embodiments of the present invention provide a method, an apparatus, and a system for detecting a rogue wireless access point to solve a problem of information leakage to a certain degree.

According to a first aspect, an embodiment of the present invention provides a method for detecting a rogue AP, including obtaining, by an authentication client using an operating system application programming interface (API), a basic service set identifier (BSSID) of a radio signal to be connected; checking, by the authentication client, the BSSID of the radio signal to be connected against a valid BSSID list, where the valid BSSID list includes a BSSID of each valid AP air interface; determining, by the authentication client, that an AP corresponding to the BSSID of the radio signal to be connected is a rogue AP when the BSSID of the radio signal to be connected does not exist in the valid BSSID list; and generating, by the authentication client, a prompt message, where the prompt message is used to indicate that the AP corresponding to the BSSID of the radio signal to be connected is a rogue AP.

In a first possible implementation manner, with reference to the first aspect, information about the BSSID of each valid AP air interface comes from a network manager.

In a second possible implementation manner, with reference to the first possible implementation manner of the first aspect, before the checking, by the authentication client, the BSSID of the radio signal to be connected against a valid BSSID list, the method further includes receiving, by the authentication client, the valid BSSID list sent by the network manager, where the valid BSSID list is any one of the following two lists: a BSSID list made by the network manager for the first time and an updated valid BSSID list made by the network manager.

In a third possible implementation manner, with reference to the first possible implementation manner of the first aspect, before the checking, by the authentication client, the BSSID of the radio signal to be connected against a valid BSSID list, the method further includes receiving, by the authentication client, the BSSID of each valid AP air interface sent by the network manager; and making, by the authentication client, the valid BSSID list from the received BSSID of each valid AP air interface.

In a fourth possible implementation manner, with reference to the first possible implementation manner of the first aspect, before the checking, by the authentication client, the BSSID of the radio signal to be connected against a valid BSSID list, the method further includes receiving, by the authentication client, a BSSID of a new valid AP air interface sent by the network manager; and making, by the authentication client, an updated valid BSSID list from the existing BSSID of each valid AP air interface and the BSSID of the new valid AP air interface.

In a fifth possible implementation manner, with reference to the first aspect or any possible implementation manner of the first aspect, the authentication client is deployed on a user equipment (UE).

According to a second aspect, an embodiment of the present invention provides another method for detecting a rogue AP, including obtaining, by a network manager, a BSSID of each valid AP air interface; and sending, by the network manager, the BSSID of each valid AP air interface to an authentication client, where the BSSID of each valid AP air interface is used by the authentication client to check an obtained BSSID of a radio signal to be connected against the BSSID of each valid AP air interface and determine, using a check result, whether an AP corresponding to the BSSID of the radio signal to be connected is a rogue AP.

In a first possible implementation manner, with reference to the second aspect, the sending, by the network manager, the BSSID of each valid AP air interface to an authentication client includes making, by the network manager, a valid BSSID list from the BSSID of each valid AP air interface, and sending the valid BSSID list to the authentication client, where the valid BSSID list includes the BSSID of each valid AP air interface.

In a second possible implementation manner, with reference to the first possible implementation manner of the second aspect, the making, by the network manager, a valid BSSID list from the BSSID of each AP air interface includes making, by the network manager, the valid BSSID list according to a file format set by the authentication client for a valid BSSID list.

In a third possible implementation manner, with reference to the second aspect or the second possible implementation manner of the second aspect, the method further includes any one of the following steps: each time when the network manager obtains a BSSID of a new AP air interface, re-making, by the network manager, an updated valid BSSID list, and sending the updated valid BSSID list to the authentication client; and each time when the network manager obtains a BSSID of a new AP air interface, sending, by the network manager, the BSSID of the new AP air interface to the authentication client.

In a fourth possible implementation manner, with reference to the second aspect any possible implementation manners of the second aspect, the obtaining, by a network manager, a BSSID of each valid AP air interface includes any one of the following steps: receiving, by the network manager, the BSSID of each valid AP interface sent by an access controller (AC); receiving, by the network manager, the BSSID of each valid AP air interface sent by a valid AP; and collecting, by the network manager, the BSSID of each valid AP air interface on a timed basis or using a trigger signaling, where the trigger signaling is used to instruct the network manager to actively collect the BSSID of each valid AP air interface.

According to a third aspect, an embodiment of the present invention provides an apparatus for detecting a rogue AP, including an obtaining module configured to obtain, using an operating system API, a BSSID of a radio signal to be connected, and send the BSSID of the radio signal to be connected to a checking module; the checking module configured to check the BSSID, which is obtained by the obtaining module, of the radio signal to be connected against a valid BSSID list, and provide a check result for a determining module, where the valid BSSID list includes a BSSID of a valid AP air interface; the determining module configured to, when the check result is that the BSSID of the radio signal to be connected does not exist in the valid BSSID list, determine that an AP corresponding to the BSSID of the radio signal to be connected is a rogue AP, and provide an identifier of the rogue AP for a generating module; and the generating module configured to generate a prompt message, where the prompt message is used to indicate that the AP corresponding to the BSSID of the radio signal to be connected is a rogue AP.

According to a fourth aspect, an embodiment of the present invention provides another apparatus for detecting a rogue AP, including an obtaining module configured to obtain a BSSID of each valid AP air interface, and provide the BSSID of each valid AP air interface for a sending module; and the sending module configured to send the BSSID of each valid AP air interface obtained by the obtaining module to an authentication client, where the BSSID of each valid AP air interface is used by the authentication client to check an obtained BSSID of a radio signal to be connected against the BSSID of each valid AP air interface and determine, using a check result, whether an AP corresponding to the BSSID of the radio signal to be connected is a rogue AP.

In a first possible implementation manner, with reference to the third aspect, information about the BSSID of each valid AP air interface comes from a network manager.

In a second possible implementation manner, with reference to the first possible implementation manner of the third aspect, the apparatus further includes a first receiving module configured to receive the valid BSSID list sent by the network manager, and provide the valid BSSID list for the checking module, where the valid BSSID list is any one of the following two lists: a BSSID list made by the network manager for the first time and an updated valid BSSID list made by the network manager.

In a third possible implementation manner, with reference to the first possible implementation manner of the third aspect, the apparatus further includes a second receiving module configured to receive the BSSID of each valid AP air interface sent by the network manager, and provide the BSSID of each valid AP air interface for the generating module; and the generating module is configured to make the valid BSSID list from the BSSID of each valid AP air interface.

In a fourth possible implementation manner, with reference to the third possible implementation manner of the third aspect, the second receiving module is further configured to receive a BSSID of a new valid AP air interface sent by the network manager, and provide the BSSID of the new valid AP air interface for the generating module; and the generating module is further configured to make an updated valid BSSID list from the existing BSSID of each valid AP air interface and the BSSID of the new valid AP air interface.

In a fifth possible implementation manner, with reference to the third aspect or any possible implementation manner of the third aspect, the apparatus is deployed on a UE.

According to a fifth aspect, an embodiment of the present invention provides a system for detecting a rogue AP, including an authentication client configured to obtain, using an operating system API, a BSSID of a radio signal to be connected; check the BSSID of the radio signal to be connected against a valid BSSID list, where the valid BSSID list includes a BSSID of each valid AP air interface; determine that an AP corresponding to the BSSID of the radio signal to be connected is a rogue AP when the BSSID of the radio signal to be connected does not exist in the valid BSSID list; and generate a prompt message, where the prompt message is used to indicate that the AP corresponding to the BSSID of the radio signal to be connected is a rogue AP; and a network manager configured to obtain the BSSID of each valid AP air interface; and send the BSSID of each valid AP air interface to the authentication client, where the BSSID of each valid AP air interface is used by the authentication client to check the obtained BSSID of the radio signal to be connected against the BSSID of each valid AP air interface and determine, using a check result, whether the AP corresponding to the BSSID of the radio signal to be connected is a rogue AP.

In the method, apparatus, and system for detecting a rogue AP, an authentication client checks an obtained BSSID of a radio signal to be connected against a valid BSSID list; when the authentication client cannot find the BSSID of the radio signal to be connected in the valid BSSID list, it indicates that an AP corresponding to the BSSID of the radio signal to be connected is a rogue AP. After the authentication client determines a rogue AP, a UE where the authentication client is located can be forbidden to connect to the rogue AP, without the need to further determine whether the rogue AP is a malicious rogue AP, thereby achieving a purpose of avoiding information leakage to a certain degree.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a schematic structural diagram of a system for detecting a rogue AP according to an embodiment of the present invention;

FIG. 2 is a schematic structural diagram of another system for detecting a rogue AP according to an embodiment of the present invention;

FIG. 3 is a flowchart of a method for detecting a rogue AP according to an embodiment of the present invention;

FIG. 4 is a flowchart of another method for detecting a rogue AP according to an embodiment of the present invention;

FIG. 5 is a schematic diagram of a file format in a valid BSSID list in a method for detecting a rogue AP according to an embodiment of the present invention;

FIG. 6 is a flowchart of a method for receiving a BSSID of each valid AP air interface by a network manager in a method for detecting a rogue AP according to an embodiment of the present invention;

FIG. 7 is a flowchart of another method for receiving a BSSID of each valid AP air interface by a network manager in a method for detecting a rogue AP according to an embodiment of the present invention;

FIG. 8 is a flowchart of still another method for detecting a rogue AP according to an embodiment of the present invention;

FIG. 9 is a schematic structural diagram of an apparatus for detecting a rogue AP according to an embodiment of the present invention;

FIG. 10 is a schematic structural diagram of another apparatus for detecting a rogue AP according to an embodiment of the present invention;

FIG. 11 is a schematic structural diagram of still another apparatus for detecting a rogue AP according to an embodiment of the present invention;

FIG. 12 is a schematic structural diagram of yet another apparatus for detecting a rogue AP according to an embodiment of the present invention;

FIG. 13 is a hardware structural diagram of an authentication client in a method for detecting a rogue AP according to an embodiment of the present invention; and

FIG. 14 is a hardware structural diagram of a network manager in a method for detecting a rogue AP according to an embodiment of the present invention.

### DESCRIPTION OF EMBODIMENTS

The following clearly describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

A method for detecting a rogue AP of the present invention is applicable to a system for detecting a rogue AP. As shown in FIG. 1, the system includes an authentication client 102 and a network manager 101.

The authentication client 102 is configured to obtain, using an API of an operating system, a BSSID of a radio signal to be connected; check the BSSID of the radio signal to be connected against a valid BSSID list, where the valid BSSID list includes a BSSID of each valid AP air interface; determine that an AP corresponding to the BSSID of the radio signal to be connected is a rogue AP when the BSSID of the radio signal to be connected does not exist in the valid BSSID list; and generate a prompt message, where the prompt message is used to indicate that the AP corresponding to the BSSID of the radio signal to be connected is a rogue AP.

The network manager 101 is configured to obtain the BSSID of each valid AP air interface; and send the BSSID of each valid AP air interface to the authentication client 102, where the BSSID of each valid AP air interface is used by the authentication client 102 to check the obtained BSSID of the radio signal to be connected against the BSSID of each valid AP air interface and determine, using a check result, whether the AP corresponding to the BSSID of the radio signal to be connected is a rogue AP.

It should be noted that the authentication client 102 is deployed on a UE. Information about the BSSID of each valid AP air interface comes from the network manager 101.

It should be further noted that one manner of obtaining the valid BSSID list by the authentication client 102 is as follows. The authentication client 102 receives the valid BSSID list sent by the network manager 101, where the valid BSSID list is any one of the following two lists: a BSSID list made by the network manager 101 for the first time and an updated valid BSSID list made by the network manager 101. Each time when receiving a BSSID of a new AP air interface, the network manager 101 re-makes an updated valid BSSID list, and sends the updated valid BSSID list to the authentication client 102. Accordingly, the authentication client 102 receives the updated valid BSSID list sent by the network manager 101.

Another manner of obtaining the valid BSSID list by the authentication client 102 is as follows. The authentication client 102 receives the BSSID of each valid AP air interface sent by the network manager 101, and makes a valid BSSID list from the received BSSID of each valid AP air interface. Each time when receiving a BSSID of a new AP air interface, the network manager 101 directly sends the received BSSID of the new AP air interface to the authentication client 102. Accordingly, after receiving the BSSID of the new AP air interface sent by the network manager 101, the authentication client 102 makes an updated valid BSSID list from the existing BSSID of each valid AP air interface and the BSSID of the new valid AP air interface.

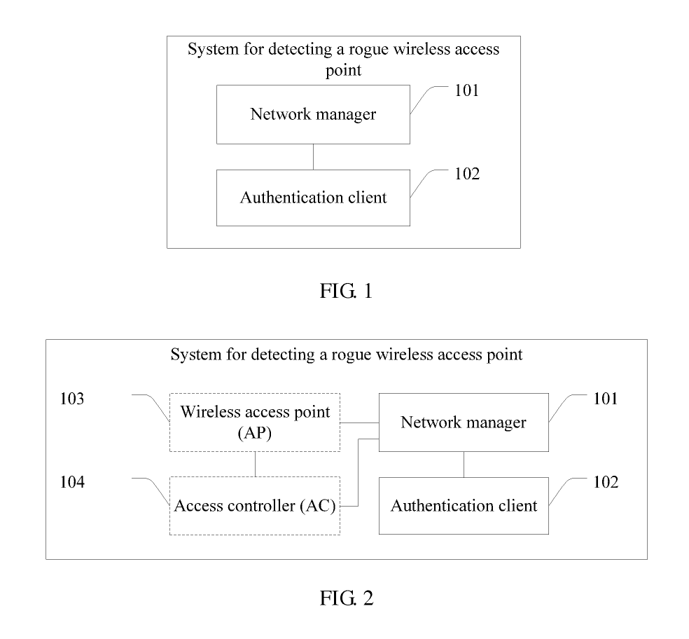

Further, an embodiment of the present invention further includes another system for detecting a rogue AP. As shown in FIG. 2, the system further includes an AP 103 and an AC 104.

The AP 103 is configured to provide a BSSID corresponding to the AP 103 for any one of the following apparatuses: the network manager 101 and the AC 104.

The AC 104 is configured to provide the BSSID of the AP 103 for the network manager 101. The AP 103 includes a valid AP and may also include a rogue AP. The AP 103 may be classified into a fat AP and a fit AP.

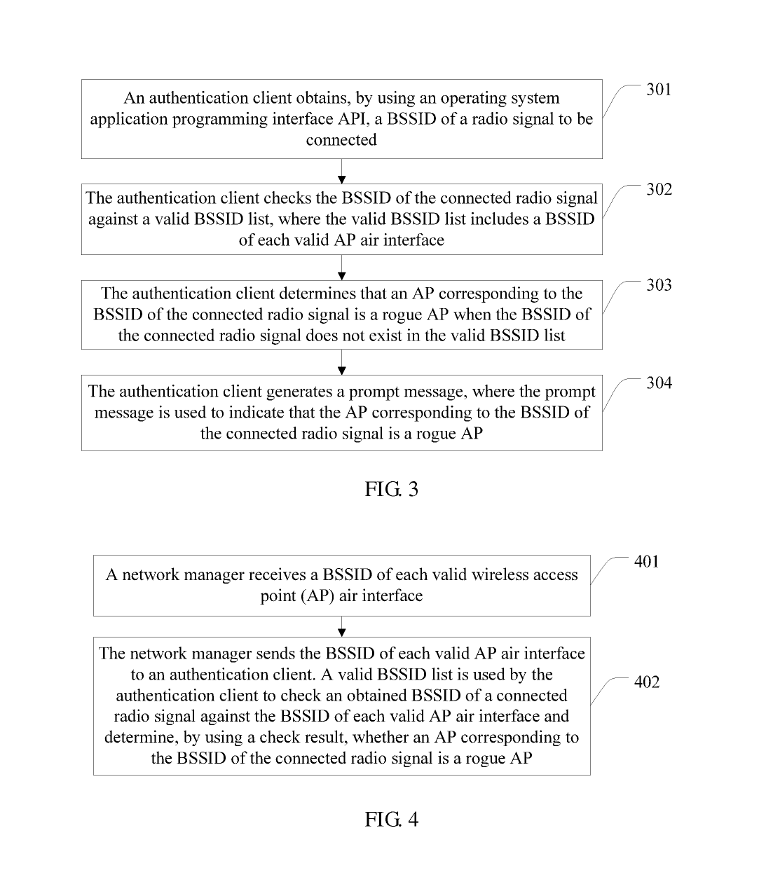

As shown in FIG. 3, an embodiment of the present invention provides a method for detecting a rogue AP, where the method includes the following steps:

301. An authentication client obtains, using an operating system API, a BSSID of a radio signal to be connected.

The authentication client is a client using a workstation/server-based input control mechanism and authentication protocol which is defined by the Institute of Electrical and Electronics Engineers (IEEE) 802.1x standard on the basis of the IEEE 802 network structure. It is generally deployed on a UE.

The BSSID is used to identify a basic service set (BSS). A format of the BSSID is the same as a format of an IEEE media access control (MAC) address, that is, a 48-bit address format. Generally, the BSSID may be regarded as a MAC address of an AP.

302. The authentication client checks the BSSID of the radio signal to be connected against a valid BSSID list, where the valid BSSID list includes a BSSID of each valid AP air interface.

Information about the BSSID of each valid AP air interface comes from a network manager.

It should be noted that, before the authentication client checks the BSSID of the radio signal to be connected against the valid BSSID list, there are two methods for obtaining the valid BSSID list by the authentication client.

Method 1: The authentication client receives the valid BSSID list sent by the network manager, where the valid BSSID list may be a BSSID list made by the network manager for the first time, or the valid BSSID list may be an updated BSSID list made by the network manager.

Method 2: The authentication client receives the BSSID of each valid AP air interface sent by the network manager, and then makes a valid BSSID list from the received BSSID of each valid AP air interface. It is understandable that, after the network manager sends a BSSID of a new valid AP air interface to the authentication client, the authentication client makes an updated valid BSSID list from the received BSSID of the new valid AP air interface and the existing BSSID of each valid AP air interface.

303. The authentication client determines that an AP corresponding to the BSSID of the radio signal to be connected is a rogue AP when the BSSID of the radio signal to be connected does not exist in the valid BSSID list.

When the authentication client cannot find the BSSID of the radio signal to be connected in the valid BSSID list, it indicates that the AP corresponding to the BSSID of the radio signal to be connected is a rogue AP.

304. The authentication client generates a prompt message, where the prompt message is used to indicate that the AP corresponding to the BSSID of the radio signal to be connected is a rogue AP.

After determining a rogue AP, the authentication client generates a prompt message, so as to forbid an access-allowed UE from connecting to the rogue AP.

When the authentication client has a relatively high security requirement, the prompt message generated by the authentication client further carries an instruction to forbid a connection to the rogue AP, which indicates that the authentication client strictly forbids a UE from connecting to the rogue AP; and when the authentication client has a relatively low security requirement, the prompt message generated by the authentication client only needs to be used to warn that the AP is a rogue AP, and whether a UE connects to the rogue AP is determined by a user who holds the UE.

Compared with a post-event preventing manner in the prior art where, after a malicious rogue AP is determined, a specific AP sends a deauth frame or a disassoc frame to the malicious rogue AP through a broadcast channel in a timed and persistent manner, so as to force a user connecting to the malicious rogue AP to go offline and force the user to go offline after the user automatically re-connects to the malicious rogue AP again in a subsequent process, which still causes a problem of information leakage when the user is not forced to disconnect from the malicious rogue AP. This embodiment of the present invention is a pre-event preventing manner that, before a UE connects to a rogue AP, an authentication client determines that an AP corresponding to a BSSID of a radio signal to be connected by the UE is a rogue AP, so that the UE is forbidden to connect to the rogue AP. In the present invention, firstly, it is only needed to determine whether an AP is a rogue AP; and then, before a UE connects to a rogue AP, the UE is prevented from connecting to the rogue AP, thereby avoiding information leakage to a certain degree.

As shown in FIG. 4, an embodiment of the present invention provides another method for detecting a rogue AP, where the method includes the following steps:

401. A network manager receives a BSSID of each valid AP air interface.

In this embodiment, there are three manners of receiving the BSSID of each valid AP air interface by the network manager.

First manner: The network manager receives the BSSID of each valid AP air interface sent by an AC.

Second manner: The network manager receives the BSSID of each valid AP air interface sent by a valid AP.

Third manner: The network manager collects the BSSID of each valid AP air interface on a timed basis or using a trigger signaling. In the third manner, a cycle range within which the network manager actively collects the BSSID of each valid AP air interface is not limited in this embodiment. For example, 5 s and 10 s are both applicable. A time interval at which the network manager collects the BSSID of each valid AP air interface may be determined according to a frequency of adding a BSSID by a valid AP. The trigger signaling is used to instruct the network manager to actively collect the BSSID of each valid AP air interface, and the trigger signaling may be sent by the AC, or may be sent by a valid AP.

It is understandable that the network manager may receive data (for example, the BSSID of each valid AP air interface) using the Simple Network Management Protocol (SNMP) interface, the remote login Telnet, the Hypertext Transfer Protocol (HTTPS), or other manners.

402. The network manager sends the BSSID of each valid AP air interface to an authentication client. A valid BSSID list is used by the authentication client to check an obtained BSSID of a radio signal to be connected against the BSSID of each valid AP air interface and determine, using a check result, whether an AP corresponding to the BSSID of the radio signal to be connected is a rogue AP.

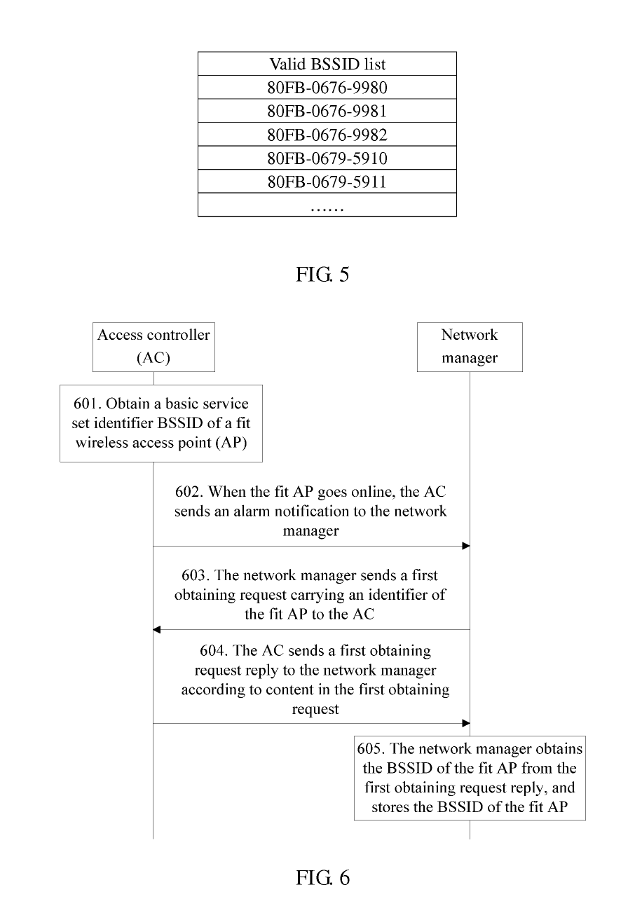

After obtaining the BSSID of each valid AP air interface in the foregoing three manners, optionally, the network manager may aggregate the BSSID to generate a valid BSSID list. A file format of the valid BSSID list needs to be consistent with a file format of a valid BSSID list stored on the authentication client. In this way, the authentication client can use the valid BSSID list during subsequent detection of a rogue AP. An example of a format of the valid BSSID list is shown in FIG. 5. Certainly, the file format of the valid BSSID list is not limited in this embodiment, so long as the file format follows the file format of the valid BSSID list on the authentication client. Alternatively, the BSSID of each valid AP interface may be directly sent to the authentication client.

In this implementation manner of the present invention, a network manager sends obtained BSSIDs of valid AP air interfaces to an authentication client, so that the authentication client checks, using the BSSID of each valid AP, a BSSID of a radio signal to be connected. In this way, the authentication client can determine whether an AP corresponding to the BSSID of the radio signal to be connected is a rogue AP. This implements a pre-event preventing manner that, before a UE connects to a rogue AP, the UE is informed that an AP corresponding to a BSSID of a radio signal to be connected is a rogue AP, so that the UE is forbidden to connect to the rogue AP, which can avoid information leakage to a certain degree.

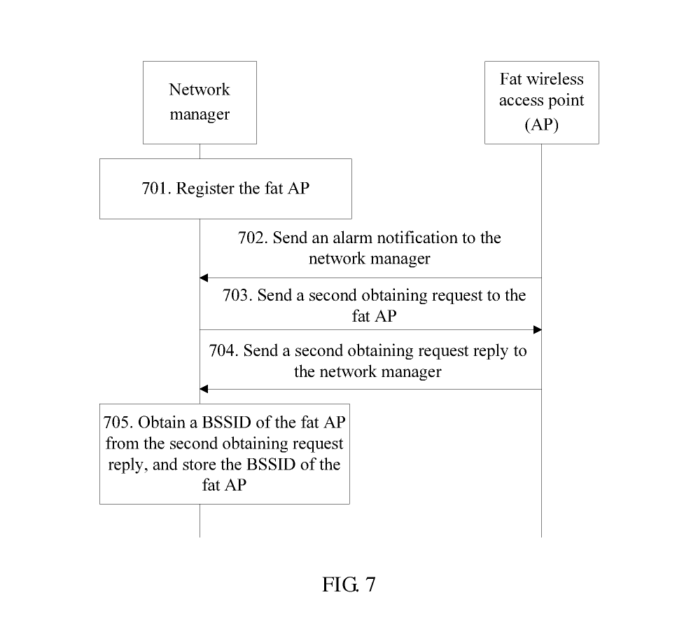

In this implementation manner of the present invention, in step 401 in FIG. 4, two manners of receiving the BSSID of each valid AP air interface by the network manager are briefly described. The first manner is used by the network manager to obtain a BSSID of a fit AP air interface. The second manner is used by the network manager to obtain a BSSID of a fat AP air interface. For details about the first manner, refer to FIG. 6; and for details about the second manner, refer to FIG. 7.

In FIG. 6:

601. An AC obtains a BSSID of a fit AP.

The fit AP refers to an AP that cannot perform configuration by itself. Generally, the fit AP requires a special device (for example, the AC) to perform centralized control, management, and configuration.

A manner of obtaining the BSSID of the fit AP by the AC includes the following: The AC first receives a first registration request of the fit AP, where the first registration request is used by the fit AP to perform registration with the AC. After receiving the first registration request, the AC performs validity check on the fit AP. When the fit AP is valid, the AC sends a first registration success reply to the fit AP. Then, the fit AP downloads configuration information from the AC, generates a virtual wireless access point (VAP) according to the configuration information, and then the fit AP selects a BSSID from a group of BSSIDs inside the fit AP, and allocates the selected BSSID to the VAP, that is, one BSSID exists for the fit AP. Optionally, the fit AP sends the BSSID corresponding to the VAP to the AC; or, the AC actively searches in a timed manner to detect whether a new BSSID appears, and when a new BSSID appears, the AC obtains the new BSSID immediately. The performing validity check on the fit AP by the AC is as follows: searching a white list to detect whether there exists an obtained management MAC address or a serial number (SN) of a wired port of the fit AP; and when the management MAC address or SN of the wired port of the fit AP exists in the white list, it indicates that the fit AP is valid.

602. When the fit AP goes online, the AC sends an alarm notification to the network manager.

The alarm notification is used to inform the network manager that the fit AP has already been online. It is understandable that the alarm notification in this step includes an identifier of the fit AP.

603. The network manager sends a first obtaining request carrying the identifier of the fit AP to the AC.

604. The AC sends a first obtaining request reply to the network manager according to content in the first obtaining request.

The first obtaining request reply includes a BSSID and basic information (for example, an AP name, an AP type, and a MAC address of the AP) of the fit AP.

605. The network manager obtains the BSSID of the fit AP from the first obtaining request reply, and stores the BSSID of the fit AP.

It is understandable that the network manager may obtain a BSSID of another fit AP using the foregoing steps 601 to 605.

In FIG. 7:

701. A network manager registers a fat AP.

The fat AP may be regarded as a wireless switch. That is, the fat AP has functions such as self-configuration and signal broadcasting.

The network manager registers the fat AP according to information such as an IP address of the fat AP and a key of the fat AP.

702. The fat AP sends an alarm notification to the network manager.

After a radio network configured by the fat AP is effective, the fat AP notifies the network manager, that is, sends an alarm notification to the network manager.

703. The network manager sends a second obtaining request to the fat AP.

704. The fat AP sends a second obtaining request reply to the network manager.

The second obtaining request reply includes a BSSID of the fat AP.

705. The network manager obtains the BSSID of the fat AP from the second obtaining request reply, and stores the BSSID of the fat AP.

It is understandable that the network manager may obtain a BSSID of another fat AP using the foregoing steps 701 to 707.

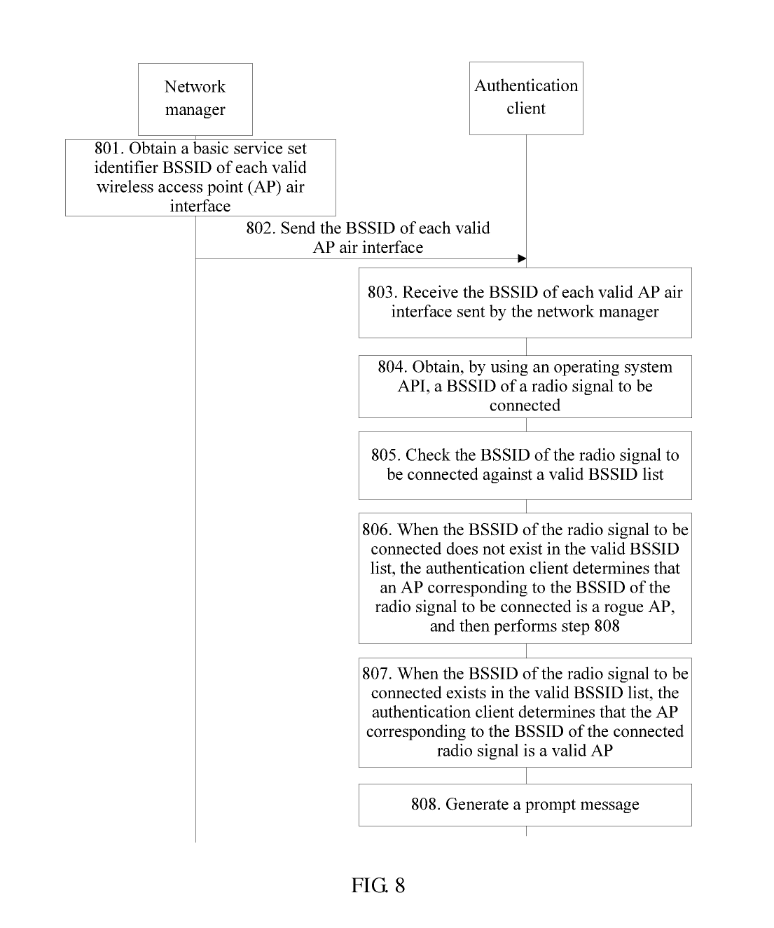

In an implementation manner of the present invention, with reference to FIG. 3 to FIG. 7, an embodiment of the present invention provides still another method for detecting a rogue AP. As shown in FIG. 8, the method includes the following steps:

801. A network manager receives a BSSID of a valid AP air interface.

Similarly, when finding that there is a new valid AP, the network manager continues to obtain a BSSID of the new valid AP air interface.

802. The network manager sends the BSSID of each valid AP air interface to an authentication client.

Each time when receiving a BSSID of a new AP air interface, the network manager re-makes an updated valid BSSID list, and then sends the updated valid BSSID list to the authentication client. Alternatively, the network manager directly sends the received BSSID of the new AP air interface to the authentication client.

803. The authentication client receives the BSSID of each valid AP air interface sent by the network manager.

The authentication client may directly receive a valid BSSID list; or the authentication client receives the BSSID of each valid AP air interface, and then makes a valid BSSID list.

It is also noted that the authentication client may receive an updated valid BSSID list sent by the network manager; or the authentication client receives a BSSID of a new valid AP air interface, and then obtains the BSSID of the new valid AP air interface, so as to make an updated valid BSSID list.

804. The authentication client obtains, using an operating system API, a BSSID of a radio signal to be connected.

805. The authentication client checks the BSSID of the radio signal to be connected against a valid BSSID list.

After the authentication client checks the BSSID of the radio signal to be connected against the valid BSSID list, when the BSSID of the radio signal to be connected does not exist in the valid BSSID list, the process proceeds to step 806; and when the BSSID of the radio signal to be connected exists in the valid BSSID list, the process proceeds to step 807.

806. The authentication client determines that an AP corresponding to the BSSID of the radio signal to be connected is a rogue AP when the BSSID of the radio signal to be connected does not exist in the valid BSSID list.

The authentication client marks the AP corresponding to the BSSID of the radio signal to be connected as a rogue AP, and then the process proceeds to step 808.

807. The authentication client determines that an AP corresponding to the BSSID of the radio signal to be connected is a valid AP when the BSSID of the radio signal to be connected exists in the valid BSSID list.

The authentication client marks the AP corresponding to the BSSID of the radio signal to be connected as a valid AP, so that a UE can connect to the valid AP securely.

808. The authentication client generates a prompt message.

After a user who holds a UE with the authentication client installed learns the prompt message, the user may input, according to the prompt message, an instruction to forbid a connection to the rogue AP, so that the UE is forbidden to connect to the rogue AP.

This embodiment of the present invention is a pre-event preventing manner that, before a UE connects to a rogue AP, an authentication client determines that an AP corresponding to a BSSID of a radio signal to be connected by the UE is a rogue AP, so that the UE is forbidden to connect to the rogue AP, which can avoid information leakage to a certain degree.

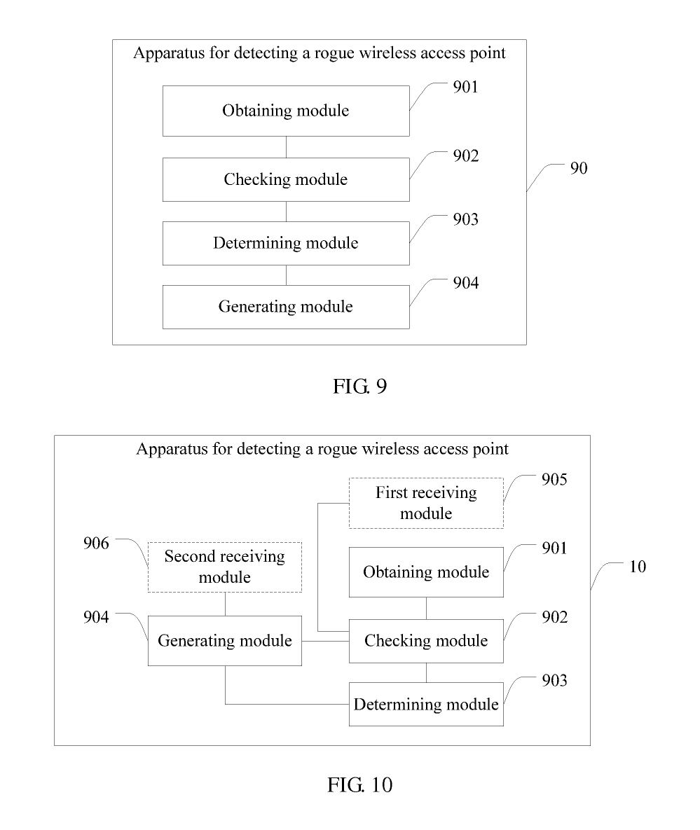

As shown in FIG. 9, an embodiment of the present invention provides an apparatus 90 for detecting a rogue AP, including an obtaining module 901, a checking module 902, a determining module 903, and a generating module 904. The apparatus 90 may be an authentication client or the apparatus 90 is disposed on a terminal.

The obtaining module 901 is configured to obtain, using an operating system API, a BSSID of a radio signal to be connected, and provide the BSSID of the radio signal to be connected for the checking module 902.

The checking module 902 is configured to check the BSSID of the radio signal to be connected against a valid BSSID list, and provide a check result for the determining module 903, where the valid BSSID list includes a BSSID of each valid AP air interface.

Information about the BSSID of each valid AP air interface comes from a network manager.

The determining module 903 is configured to determine that an AP corresponding to the BSSID of the radio signal to be connected is a rogue AP when the BSSID of the radio signal to be connected does not exist in the valid BSSID list, and provide an identifier of the rogue AP for the generating module 904.

The generating module 904 is configured to generate a prompt message, where the prompt message is used to indicate that the AP corresponding to the BSSID of the radio signal to be connected is a rogue AP.

Further, as shown in FIG. 10, an embodiment of the present invention further provides an apparatus 10 for detecting a rogue AP, where the apparatus 10 further includes a first receiving module 905 and a second receiving module 906.

Further, optionally, the first receiving module 905 is configured to receive the valid BSSID list sent by a network manager, and provide the valid BSSID list for the checking module 902, where the valid BSSID list is any one of the following two lists: a BSSID list made by the network manager for the first time and an updated valid BSSID list made by the network manager.

Further, optionally, the second receiving module 906 is configured to receive the BSSID of each valid AP air interface sent by the network manager, and provide the BSSID of each valid AP air interface for the generating module 904. The generating module 904 makes a valid BSSID list from the BSSID of each valid AP air interface.

The second receiving module 906 is further configured to receive a BSSID of a new valid AP air interface sent by the network manager, and provide the BSSID of the new valid AP air interface for the generating module 904. Then, the generating module 904 makes an updated valid BSSID list from the existing BSSID of each valid AP air interface and the BSSID of the new valid AP air interface.

It should be noted that the apparatus 90 and the apparatus 10 are both deployed on a UE.

It should be noted that, in the apparatus 90 shown in FIG. 9 and the apparatus 10 shown in FIG. 10, for content such as specific implementation processes of the modules and information interaction between the modules, because it is based on the same invention idea as the method embodiments of the present invention, reference may be made to the method embodiments, which is not further described herein.

This embodiment of the present invention is a pre-event preventing manner that, before a UE connects to a rogue AP, an authentication client determines that an AP corresponding to a BSSID of a radio signal to be connected by the UE is a rogue AP, so that the UE is forbidden to connect to the rogue AP, which can avoid information leakage to a certain degree.

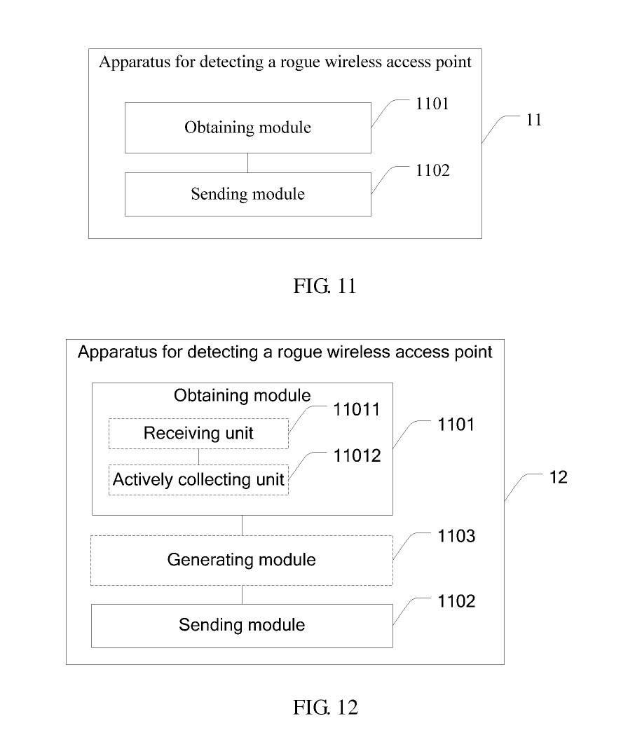

As shown in FIG. 11, an embodiment of the present invention provides another apparatus 11 for detecting a rogue AP, including an obtaining module 1101 and a sending module 1102.

The obtaining module 1101 is configured to obtain a BSSID of each valid AP air interface, and provide the BSSID of each valid AP air interface for the sending module 1102.

The sending module 1102 is configured to send the BSSID of each valid AP air interface obtained by the obtaining module 1101 to an authentication client, where the BSSID of each valid AP air interface is used by the authentication client to check an obtained BSSID of a radio signal to be connected against the BSSID of each valid AP air interface and determine, using a check result, whether an AP corresponding to the BSSID of the radio signal to be connected is a rogue AP.

Further, as shown in FIG. 12, an embodiment of the present invention further provides an apparatus 12 for detecting a rogue AP, where the apparatus 12 further includes a generating module 1103, and the obtaining module 1101 includes a receiving unit 11011 and an actively collecting unit 11012.

There are two manners of sending, by the sending module 1102, the BSSID of each valid AP air interface obtained by the obtaining module 1101 to the authentication client.

First manner: The generating module 1103 is configured to make a valid BSSID list from the BSSID of each valid AP air interface, and provide the valid BSSID list for the sending module 1102; and the sending module 1102 sends the valid BSSID list provided by the generating module 1103 to the authentication client, where the valid BS SID list includes the BSSID of each valid AP air interface. The generating module 1103 is configured to make the valid BSSID list according to a file format set by the authentication client for a valid BSSID list.

Second manner: The sending module 1102 directly sends the BSSID of each valid AP air interface to the authentication client.

It is further noted that the receiving unit 11011 in the obtaining module 1101 may receive the BSSID of each valid AP air interface sent by an AC, or receive the BSSID of each valid AP air interface sent by a valid AP. The actively collecting unit 11012 in the obtaining module 1101 collects the BSSID of each valid AP air interface on a timed basis or using a trigger signaling, where the trigger signaling is used to instruct the network manager to actively collect the BSSID of each valid AP air interface.

Further, the obtaining module 1101 is further configured to obtain a BSSID of a new AP air interface, and provide the BSSID of the new AP air interface for any one of the following modules: the generating module 1103 and the sending module 1102.

The generating module 1103 re-makes an updated valid BSSID list according to the BSSID of the new AP air interface obtained by the obtaining module 1101, and provides the updated valid BSSID list for the sending module 1102. Then, the sending module 1102 sends the updated valid BSSID list to the authentication client.

Alternatively, the sending module 1102 directly sends the BSSID of the new AP air interface obtained by the obtaining module 1101 to the authentication client.

It should be noted that, in the apparatus 11 shown in FIG. 11 and the apparatus 12 shown in FIG. 12, for content such as specific implementation processes of the modules and information interaction between the modules, because it is based on the same invention idea as the method embodiments of the present invention, reference may be made to the method embodiments, which is not further described herein.

This embodiment of the present invention is a pre-event preventing manner that, before a UE connects to a rogue AP, an authentication client determines that an AP corresponding to a BSSID of a radio signal to be connected by the UE is a rogue AP, so that the UE is forbidden to connect to the rogue AP, which can avoid information leakage to a certain degree.

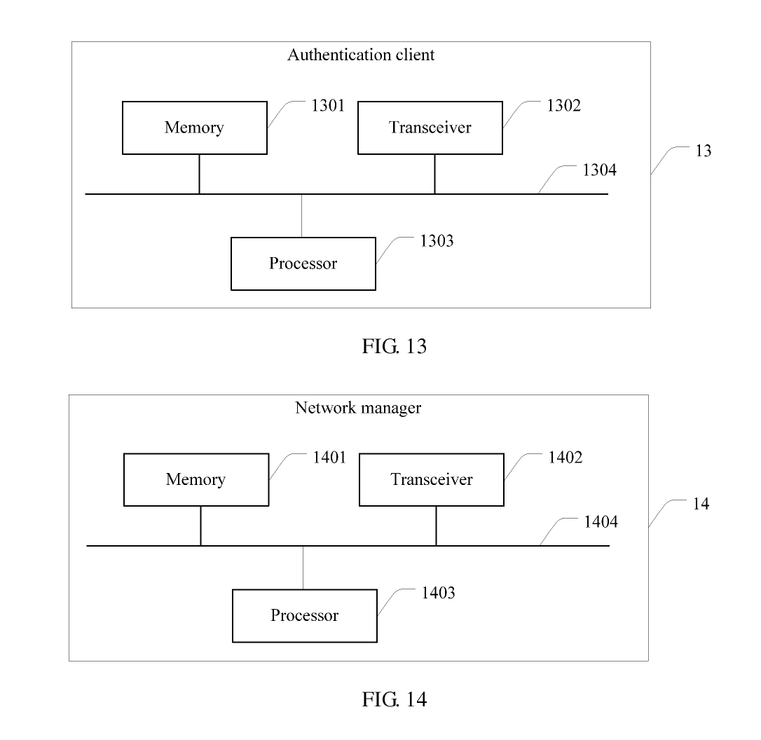

As shown in FIG. 13, FIG. 13 is a schematic hardware structural diagram of an authentication client 13. The authentication client 13 may include a memory 1301, a transceiver 1302, a processor 1303, and a bus 1304, where the memory 1301, the transceiver 1302, and the processor 1303 are communicatively connected by means of the bus 1304.

The memory 1301 may be a read-only memory (ROM), a static storage device, a dynamic storage device or a random access memory (RAM). The memory 1301 may store an operating system and one or more other applications. When the technical solution provided in this embodiment of the present invention is implemented using software or firmware, program code used to implement the technical solution provided in this embodiment of the present invention is stored in the memory 1301, and is executed by the processor 1303.

The transceiver 1302 is configured for communication between the apparatus and another device or a communications network (for example, but not limited to, Ethernet, a radio access network (RAN), and a wireless local area network (WLAN)).

The processor 1303 may adopt a universal central processing unit (CPU), a microprocessor, an application specific integrated circuit (ASIC) or one or more integrated circuits, and is configured to execute a related program so as to implement the technical solution provided in this embodiment of the present invention.

The bus 1304 may include a path to transmit information between parts (for example, the memory 1301, the transceiver 1302, and the processor 1303) of the apparatus. The bus 1304 may be an Industry Standard Architecture (ISA) bus, a Peripheral Component Interconnect (PCI) bus, an Extended Industry Standard Architecture (EISA) bus, or the like. The bus may be one or more physical lines. When the bus is many physical lines, the bus may be classified into an address bus, a data bus, a control bus, and the like.

It should be noted that, although the hardware shown in FIG. 13 illustrates only the memory 1301, the transceiver 1302, the processor 1303, and the bus 1304, in a specific implementation process, a person skilled in the art should understand that the terminal further includes other components required for normal operation. In addition, according to a specific requirement, a person skilled in the art should understand that the terminal may further include a hardware component that implements one or more other functions.

When the authentication client 13 shown in FIG. 13 is configured to implement the apparatus shown in FIG. 7 and FIG. 8, the transceiver 1302 in the apparatus is configured to obtain, using an operating system API, a BSSID of a radio signal to be connected, and provide the BSSID of the radio signal to be connected for the processor 1303.

The processor 1303 is connected to the memory 1301 and the transceiver 1302 separately, and is configured to check the BSSID, which is obtained by the transceiver 1302, of the radio signal to be connected against a valid BSSID list, where the valid BSSID list includes a BSSID of each valid AP air interface; determine that an AP corresponding to the BSSID of the radio signal to be connected is a rogue AP when the BSSID of the radio signal to be connected does not exist in the valid BSSID list; and then generate a prompt message, where the prompt message is used to indicate that the AP corresponding to the BSSID of the radio signal to be connected is a rogue AP.

Information about the BSSID of each valid AP air interface comes from a network manager.

Further, before the transceiver 1302 obtains the BSSID of the radio signal to be connected, the transceiver 1302 is further configured to receive the valid BSSID list sent by the network manager, and provide the valid BSSID list for the processor 1303, where the valid BSSID list is any one of the following two lists: a BSSID list made by the network manager for the first time and an updated valid BSSID list made by the network manager.

Further, before the transceiver 1302 obtains the BSSID of the radio signal to be connected, the transceiver 1302 is further configured to receive the BSSID of each valid AP air interface sent by the network manager, and provide the BSSID of each valid AP air interface for the processor 1303. The processor 1303 makes a valid BSSID list from the BSSID of each valid AP air interface.

The transceiver 1302 is further configured to receive a BSSID of a new valid AP air interface sent by the network manager, and provide the BSSID of the new valid AP air interface for the processor 1303. Then, the processor 1303 makes an updated valid BSSID list from the existing BSSID of each valid AP air interface and the BSSID of the new valid AP air interface.

It should be noted that the apparatus 13 (the authentication client) is deployed on a UE.

This embodiment of the present invention is a pre-event preventing manner that, before a UE connects to a rogue AP, an authentication client informs the UE that an AP corresponding to a BSSID of a radio signal to be connected is a rogue AP, so that the UE is forbidden to connect to the rogue AP, which can avoid information leakage to a certain degree.

As shown in FIG. 14, FIG. 14 is a schematic hardware structural diagram of a network manager 14. The network manager 14 may include a memory 1401, a transceiver 1402, a processor 1403, and a bus 1404. The memory 1401, the transceiver 1402, and the processor 1403 are communicatively connected by means of the bus 1404.

In the apparatus, for an overview of functions common to the memory 1401, the transceiver 1402, the processor 1403, and the bus 1404, and the memory 1301, the transceiver 1302, the processor 1303, and the bus 1304, reference may be made to the descriptions of the memory 1301, the transceiver 1302, the processor 1303, and the bus 1304 included in the authentication client shown in FIG. 10, which is not further described herein.

It should be noted that, although the hardware shown in FIG. 14 illustrates only the memory 1401, the transceiver 1402, the processor 1403, and the bus 1404, in a specific implementation process, a person skilled in the art should understand that the terminal further includes other components required for normal operation. In addition, according to a specific requirement, a person skilled in the art should understand that the terminal may further include a hardware component that implements one or more other functions.

When the network manager 14 shown in FIG. 14 is configured to implement the apparatus shown in the embodiment in FIG. 9, the transceiver 1402 in the apparatus is configured to obtain a BSSID of each valid AP air interface, and provide the BSSID of each valid AP air interface for the processor 1403.

The transceiver 1402 is configured to receive the BSSID of each valid AP air interface sent by an AC; or, receive the BSSID of each valid AP air interface sent by a valid AP; or collect the BSSID of each valid AP air interface on a timed basis or using a trigger signaling, where the trigger signaling is used to instruct the transceiver 1402 to actively collect the BSSID of each valid AP air interface.

Then, the transceiver 1402 sends the BSSID of each valid AP air interface to an authentication client, where the BSSID of each valid AP air interface is used by the authentication client to check an obtained BSSID of a radio signal to be connected against the BSSID of each valid AP air interface and determine, using a check result, whether an AP corresponding to the BSSID of the radio signal to be connected is a rogue AP.

There are two manners of sending, by the transceiver 1402, the BSSID of each valid AP air interface to the authentication client.

First manner: The transceiver 1402 provides the BSSID of each valid AP air interface for the processor 1403, and then, the processor 1403 is connected to the memory 1401 and the transceiver 1402 separately, and is configured to make a valid BSSID list from the BSSID of each valid AP air interface received by the transceiver 1402, and provide the valid BSSID list for the transceiver 1402; then, the transceiver 1402 sends the valid BSSID list provided by the processor 1403 to the authentication client, where the valid BSSID list includes the BSSID of each valid AP air interface. The processor 1403 makes the valid BSSID list according to a file format set by the authentication client for a valid BSSID list.

Second manner: The transceiver 1402 directly sends the BSSID of each valid AP air interface to the authentication client.

It should be further noted that each time when the transceiver 1402 receives a BSSID of a new AP air interface, the processor 1403 re-makes an updated valid BSSID list, and provides the updated valid BSSID list for the transceiver 1402. Then, the transceiver 1402 sends the updated valid BSSID list to the authentication client. Alternatively, the transceiver 1402 directly sends the BSSID of the new AP air interface to the authentication client.

This embodiment of the present invention is a pre-event preventing manner that, before a UE connects to a rogue AP, an authentication client informs the UE that an AP corresponding to a BSSID of a radio signal to be connected is a rogue AP, so that the UE is forbidden to connect to the rogue AP, which can avoid information leakage to a certain degree.

It may be clearly understood by a person skilled in the art that, for the purpose of convenient and brief description, the division of the foregoing functional modules is merely used as an example, and the foregoing functions may be assigned to different functional modules according to an actual need, that is, an internal structure of the apparatus is divided into different functional modules, to complete all or a part of the functions described above. For a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiments are merely exemplary. For example, the division of modules or units is merely a division of logical functions and there may be other divisions in actual implementation. For example, a plurality of units or components may be combined or integrated into another system, or some features may be ignored or not performed. Furthermore, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to an actual need to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in a form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server, or a network device) or a processor to perform all or a part of the steps of the methods described in the embodiments of the present invention. The foregoing storage medium includes any medium that can store program code, such as a universal serial bus (USB) flash drive, a removable hard disk, a read-only memory (ROM), a random access memory (RAM), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for detecting a rogue wireless access point (AP) comprising:
obtaining, by an authentication client, using an operating system application programming interface (API), a basic service set identifier (BSSID) of a radio signal to be connected;
checking, by the authentication client, the BSSID of the radio signal to be connected against a valid BSSID list, wherein the valid BSSID list comprises a BSSID of each valid AP air interface;
determining, by the authentication client, that an AP corresponding to the BSSID of the radio signal to be connected is a rogue AP when the BSSID of the radio signal to be connected does not exist in the valid BSSID list; and
generating, by the authentication client, a prompt message, wherein the prompt message is used to indicate that the AP corresponding to the BSSID of the radio signal to be connected is the rogue AP.

2. The method for detecting the rogue AP according to claim 1, wherein information about the BSSID of each valid AP air interface comes from a network manager.

3. The method for detecting the rogue AP according to claim 2, wherein, before checking, by the authentication client, the BSSID of the radio signal to be connected against the valid BSSID list, the method further comprises receiving, by the authentication client, the valid BSSID list sent by the network manager, wherein the valid BSSID list is any one of the following two lists: a BSSID list made by the network manager for the first time and an updated valid BSSID list made by the network manager.

4. The method for detecting the rogue AP according to claim 2, wherein, before checking, by the authentication client, the BSSID of the radio signal to be connected against the valid BSSID list, the method further comprises:
receiving, by the authentication client, the BSSID of each valid AP air interface sent by the network manager; and
making, by the authentication client, the valid BSSID list from the received BSSID of each valid AP air interface.

5. The method for detecting the rogue AP according to claim 2, wherein, before checking, by the authentication client, the BSSID of the radio signal to be connected against the valid BSSID list, the method further comprises:
receiving, by the authentication client, the BSSID of a new valid AP air interface sent by the network manager; and
making, by the authentication client, an updated valid BSSID list from the existing BSSID of each valid AP air interface and the BSSID of the new valid AP air interface.

6. The method for detecting the rogue AP according to claim 1, wherein the authentication client is deployed on a user equipment (UE).

7. A method for detecting a rogue wireless access point (AP), comprising:
obtaining, by a network manager, a basic service set identifier (BSSID) of each valid AP air interface; and
sending, by the network manager, the BSSID of each valid AP air interface to an authentication client, wherein the BSSID of each valid AP air interface is used by the authentication client to check an obtained BSSID of a radio signal to be connected against the BSSID of each valid AP air interface and determine, using a check result, whether an AP corresponding to the BSSID of the radio signal to be connected is a rogue AP.

8. The method for detecting the rogue AP according to claim 7, wherein sending, by the network manager, the BSSID of each valid AP air interface to the authentication client comprises:
making, by the network manager, a valid BSSID list from the BSSID of each valid AP air interface; and
sending the valid BSSID list to the authentication client, wherein the valid BSSID list comprises the BSSID of each valid AP air interface.

9. The method for detecting the rogue AP according to claim 8, wherein making, by the network manager, the valid BSSID list from the BSSIDs of valid AP air interfaces comprises making, by the network manager, the valid BSSID list according to a file format set by the authentication client for the valid BSSID list.

10. The method for detecting the rogue AP according to claim 7, further comprising:
re-making, by the network manager, an updated valid BSSID list each time the network manager obtains the BSSID of a new AP air interface;
sending the updated valid BSSID list to the authentication client; and
sending, by the network manager, the BSSID of the new AP air interface to the authentication client each time the network manager obtains the BSSID of the new AP air interface.

11. The method for detecting the rogue AP according to claim 7, wherein obtaining, by the network manager, the BSSID of each valid AP air interface comprises:
receiving, by the network manager, the BSSID of each valid AP interface sent by an access controller (AC);
receiving, by the network manager, the BSSID of each valid AP air interface sent by a valid AP; and
collecting, by the network manager, the BSSID of each valid AP air interface on a timed basis or using a trigger signaling, wherein the trigger signaling is used to instruct the network manager to actively collect the BSSID of each valid AP air interface.

12. A system for detecting a rogue wireless access point (AP), comprising:
an authentication client configured to:
obtain, using an operating system application programming interface (API), a basic service set identifier (BSSID) of a radio signal to be connected;
check the BSSID of the radio signal to be connected against a valid BSSID list, wherein the valid BSSID list comprises a BSSID of each valid AP air interface;
determine that an AP corresponding to the BSSID of the radio signal to be connected is a rogue AP when the BSSID of the radio signal to be connected does not exist in the valid BSSID list; and
generate a prompt message, wherein the prompt message is used to indicate that the AP corresponding to the BSSID of the radio signal to be connected is the rogue AP; and
a network manager configured to:
obtain the BSSID of each valid AP air interface; and
send the BSSID of each valid AP air interface to the authentication client, wherein the BSSID of each valid AP air interface is used by the authentication client to check the obtained BSSID of the radio signal to be connected against the BSSID of each valid AP air interface and determine, using a check result, whether the AP corresponding to the BSSID of the radio signal to be connected is a rogue AP.

13. An authentication client comprising:
a memory configured to store information comprising a program instruction;
a transceiver configured to obtain, using an operating system application programming interface (API), a basic service set identifier (BSSID) of a radio signal to be connected, and provide the BSSID of the radio signal to be connected for a processor; and
the processor, connected to the memory and the transceiver and configured to control execution of the program instruction, and configured to:
check the BSSID, which is obtained by the transceiver, of the radio signal to be connected against a valid BSSID list, wherein the valid BSSID list comprises a BSSID of each valid AP air interface;
determine that an AP corresponding to the BSSID of the radio signal to be connected is a rogue AP when a check result is that the BSSID of the radio signal to be connected does not exist in the valid BSSID list; and
generate a prompt message, wherein the prompt message is used to indicate that the AP corresponding to the BSSID of the radio signal to be connected is the rogue AP.

14. The authentication client according to claim 13, wherein information about the BSSID of each valid AP air interface comes from a network manager.

15. The authentication client according to claim 14, wherein the transceiver is further configured to:
receive the valid BSSID list sent by the network manager; and
provide the valid BSSID list for a checking module, wherein the valid BSSID list is any one of the following two lists: a BSSID list made by the network manager for the first time and an updated valid BSSID list made by the network manager.

16. The authentication client according to claim 15, wherein the transceiver is further configured to receive the BSSID of each valid AP air interface sent by the network manager, and provide the BSSID of each valid AP air interface for the processor, and wherein the processor is further configured to make the valid BSSID list from the BSSID of each valid AP air interface.

17. The authentication client according to claim 16, wherein the transceiver is further configured to receive the BSSID of a new valid AP air interface sent by the network manager, and provide the BSSID of the new valid AP air interface for the processor, and wherein the processor is further configured to make an updated valid BSSID list from the existing BSSID of each valid AP air interface and the BSSID of the new valid AP air interface.

18. The authentication client according to claim 13, wherein the apparatus is deployed on a user equipment (UE).

19. A network manager, comprising:
a memory configured to store information comprising a program instruction;
a transceiver configured to obtain a basic service set identifier (BSSID) of each valid wireless access point (AP) air interface; and send the obtained BSSID of each valid AP air interface to an authentication client, so that the authentication client checks an obtained BSSID of a radio signal to be connected against the BSSID of each valid AP air interface and determines, using a check result, whether an AP corresponding to the BSSID of the radio signal to be connected is a rogue AP; and
a processor, connected to the memory and the transceiver and configured to control execution of the program instruction.

20. The network manager according to claim 19, wherein the processor is configured to make a valid BSSID list from the BSSID of each valid AP air interface, and provide the valid BSSID list for the transceiver, and wherein the transceiver is further configured to send the valid BSSID list provided by the processor to the authentication client, wherein the valid BSSID list comprises the BSSID of each valid AP air interface.

21. The network manager according to claim 20, wherein the processor is further configured to make the valid BSSID list according to a file format set by the authentication client for the valid BSSID list.

22. The network manager according to claim 19, wherein the transceiver is further configured to obtain the BSSID of a new AP air interface, and provide the BSSID of the new AP air interface for the processor, wherein the processor is further configured to re-make an updated valid BSSID list according to the BSSID of the new AP air interface obtained by an obtaining module, and provide the updated valid BSSID list for the transceiver, wherein the transceiver is further configured to send the updated valid BSSID list to the authentication client, and wherein the transceiver is further configured to send the BSSID of the new AP air interface to the authentication client.

23. The network manager according to claim 19, wherein the transceiver is further configured to:
receive the BSSID of each valid AP air interface sent by an access controller (AC); or
receive the BSSID of each valid AP air interface sent by a valid AP; or
collect the BSSID of each valid AP air interface on a timed basis or using a trigger signaling, wherein the trigger signaling is used to instruct the transceiver to actively collect the BSSID of each valid AP air interface.
